(19) United States
(12) Patent Application Publication
(10) Pub. No.: US 2012/0153610 A1
(43) Pub. Date: Jun. 21, 2012

(54) ASEPTIC TRANSFER PORT

(76) Inventor: Thomas Mitchel Young, Richmond, CA (US)

(21) Appl. No.: 13/329,194

(22) Filed: Dec. 16, 2011

Related U.S. Application Data
(60) Provisional application No. 61/425,211, filed on Dec. 20, 2010.

(51) Int. Cl. F16L 53/00; F16L 19/00

(52) U.S. Cl. 285/41; 285/335

(57) ABSTRACT

Rapid transfer port (RTP) systems for transferring articles between two environments (e.g., an isolator barrier system and a transfer container) are provided. Such systems may be adapted to be mated to one another by a docking operation. More particularly, such systems may provide a container assembly for use with an RTP of the type that does not require the transfer container port (beta port) which mates, for example, with the isolator barrier system port (alpha port) to breach the integrity of the container until attachment to the isolator barrier system port (alpha port 9). The container assembly may have an enclosure that, during docking, is not required to be exposed to the clean environment such as an isolator barrier system.

### CROSS-REFERENCE TO RELATED APPLICATIONS

The present patent applications claims the priority benefit of U.S. provisional patent application No. 61/425,211 filed on Dec. 20, 2010, the disclosure of which is incorporated by reference herein.

### BACKGROUND OF THE INVENTION

1. Field of the Invention

The invention generally relates to rapid transfer port (RTP) systems for transferring articles between two environments (such as an isolator barrier system and a transfer container) that are adapted to be mated to one another by a docking operation. More particularly, the present invention may relate to a container assembly for use with an RTP of the type that does not require that the integrity of the transfer container port (e.g., a beta port) be breached until attachment with an isolator barrier system (e.g., an alpha port). The container assembly may have an enclosure that, during docking, is not required to be exposed to the clean environment such as an isolator barrier system.

The present invention may further relate to a connector assembly including an end portion for connection to a sterilization container. The connector assembly may include a releasable connector port for releasably connecting the container assembly to a treatment station for multi-purpose treatment of goods, such as pharmaceutical plugs, enclosed in the container.

The invention may also be related to a multi-treatment sterilizing system, including a multi-purpose container for treatment and storing of articles being enclosed there within. Finally, the invention may additionally relate to a method for transferring sterilized goods from a multi-purpose container.

2. Description of the Related Art

Certain manufacturing processes require the maintenance of separation between two environments to avoid contamination of the cleaner of the two environments by the dirtier of the two. This is generally accomplished with the use of specific environments with isolation barriers. For example, in the case of certain pharmaceutical products, the manufacturing process may be performed within isolation barriers to prevent contamination of the product by dust particles, bacteria, viruses, and other contaminants that may be found in ambient air. The same generally holds true for the assembly of certain medical devices. In the case of radioactive operations or bacteriological procedures, the environment within the isolation barrier may be considered “dirty” when compared to the outside ambient air. In these cases, the isolation barrier serves the function of keeping the product being handled contained and preventing the escape of such product into the external environment.

In recent years, because of the expense and operational difficulties of maintaining so-called “clean rooms” into which operators enter to carry out procedures, the use of isolation barriers has become common practice in various industries (e.g., pharmaceuticals). The isolation barriers may resemble large glove boxes in concept and may be integrated onto the machinery used to carry out the necessary manufacturing operations. A variation of these isolation barriers is what is commonly known as a RABS, Restricted Access Barrier System.

Means for transferring components, product, supplies, etc., into and out of these isolation barriers without risk of contamination of the components being transferred by the “dirty” external environment during the docking and components transfer process is desired. To generally accomplish this, isolator barrier systems and RABS feature devices called Rapid Transfer Ports (RTP) may be used. These RTP devices may be of various types, sizes, and configurations. A common type of RTP device is one that is offered by the French company La Calhene, referred to as the DPTE. This DPTE device requires rotation of the transfer container during the docking process, is generally mounted on an outer surface of the isolation barrier, and features docking attachments for a pre-sterilized transfer container housing the components to be transferred. Upon the docking process, the operator places the transfer container into alignment with the RTP and rotates the container approximately 60 degrees to complete the docking operation. The docking process firmly attaches the transfer container to the RTP and, simultaneously, the transfer container door to the RTP door. Once docked, the operator reaches inside the isolation barrier via gloves located on the isolation barrier wall and opens the RTP door with its attached transfer container door, and gains access to the components located within the transfer container. To prevent contamination of the “clean” environment, the docking process places the “dirty” surfaces of the RTP and of the transfer container in sealed contact with each other, thus not permitting “dirty” particles to escape into the “clean” environment.

Typically, the RTP system component port that is integrated into the clean room environment is identified as an “alpha” port, while the RTP component port that is integrated into the container is identified as a “beta” port.

The rotation necessary to dock the transfer container onto an RTP may cause tumbling action of the components which are contained within the transfer container. This tumbling action may be acceptable when transferring soft plastic components such as stoppers or cleaning supplies, but it is undesirable, if not prohibitive, when transferring heavy or delicate machine components. In addition, the rotation of the container upon docking does not permit interface of the container to a lifting device such as a hoist or crane. Such lifting operation may be necessary to meet the manufacturing requirements of some products.

There is also a problem with the so called “ring of concern.” Prior to docking, the face of the canister and the outside of the isolator port are exposed to the environment and are potentially contaminated. When the beta port of the canister is docked to the alpha port 9, these suspect surfaces are isolated by seals. However, when the port is opened, the canister cover must pass through the port opening. Consequently, there must be a small mechanical clearance between the outside diameter of the canister cover and the inside diameter of the port. This small ring could contain contaminants.

Additionally, the installation of a connector, or beta port, into the container surface establishes mechanical breaches in the container surface which can be entry points for biological and chemical contaminants.

Alternatively, when sterilizing small articles, such as plugs or caps for pharmaceutical purposes, it is known to use a multi-purpose container, in which the articles are submitted to several different treatments such as washing, sterilizing, and drying. Rubber plugs are usually also siliconised, all within the same multi-purpose container. Siliconising is a procedure for providing the plugs with a thin layer of silicon oil, which makes the introduction of the plugs into pharmaceutical test tubes easier.

After treating the goods in the container, it is desirable to store the container in a manner such that the risk for contamination of the sterilized goods is eliminated. In order to achieve this, the container is pressurized before storing so that the internal pressure of the container is greater than the ambient pressure. If, however, the container remains stored long enough, this pressurization can be compromised.

After storing, the goods are to be transferred to suitable packages. This must be done in a sufficiently clean environment, such as a clean room or isolator. A problem occurs, however, with respect to keeping the environment clean when it is confronted with the container that has been stored under unclean conditions. To avoid this problem, the exterior of a port of the container has to be sterilized before transfer of the goods into the clean environment through the opening. The procedure for sterilizing the port, however, is time-consuming and difficult to handle. There is also a risk that an un-sterilized port may be inserted into the clean room by mistake, since there is no way to immediately determine whether the port is clean or not.

There is therefore a need for improved systems and methods for aseptic transfer.

### SUMMARY OF INVENTION

Embodiments of the present invention provide for a sealed system for aseptic transfer. Specifically, materials may be transferred through a transfer port in a barrier wall between a first environment and a second environment on opposite sides of the barrier wall, without contamination of the first environment. Such a system may include a film associated with the transfer port in the barrier wall and separating the first environment and the second environment, a sealed transfer container having at least one portion comprised of the film, and means for creating a hole in the film upon connection of the sealed transfer container to the transfer port.

Additional embodiment may additionally include a first ring of variable width and depth internal to the container of the second environment having a perimeter in close contact with an internal surface of the film of the transfer container, the ring comprising a flange extruding from a perimeter furthest from the internal surface of the flexible film, a second ring comprised of material reactive to the means for thermally creating the hole in the film, the second ring seated within the perimeter of the first ring and when subjected to the hole creation means, acting as a cutting surface of the film located within the perimeter of the first ring, a plug of material of width equal to a width of the first ring which acts as the door of a Beta port, a third ring comprising a flange and having a diameter such that the third ring fits tightly over the perimeter of the first ring on an external surface of the transfer container, a fourth ring having a flange and an inside and outside perimeter extending through the transfer port in the barrier wall separating the first and second environments, wherein the transfer port has an inner periphery, and the outside perimeter of the fourth ring being in leak-proof sealed engagement with the periphery of the transfer port and having a first passage through the ring, a hinged door on the one side of the barrier wall moveable from a first closed position in the first passage in leak-proof sealed engagement with the inside perimeter of the first ring to a second open position free of the first passage through the first ring; and a complementary locking means on the first and second rings for rigidly securing the rings together in leak-proof sealed engagement.

### BRIEF DESCRIPTION OF THE DRAWINGS

FIG. 1 is a plan view of an exemplary beta port and cutaway of a plastic bag.

FIG. 2 is a section view of FIG. 1.

FIG. 3 is a detail view of FIG. 2.

FIG. 4 is an outside (dirty side) view of an exemplary alpha port.

FIG. 5 is a section view of FIG. 4.

FIG. 6 is a detail view of FIG. 5.

FIG. 7 is a side view of an exemplary beta port mated to an exemplary alpha port.

FIG. 8 is a section view of FIG. 7 showing an exemplary induction coil.

FIG. 9 is a plan view of an exemplary beta port mated to an exemplary alpha port from the inside (clean side).

FIG. 10 is a section view of FIG. 9.

FIG. 11 is a detail view of FIG. 10.

FIG. 12 is an inside (clean side) view of an exemplary opened port system.

FIG. 13 is a section view of FIG. 12.

FIG. 14 is a detail view of the stationary items of FIG. 13.

FIG. 15 is a detail view of the door assembly of FIG. 14.

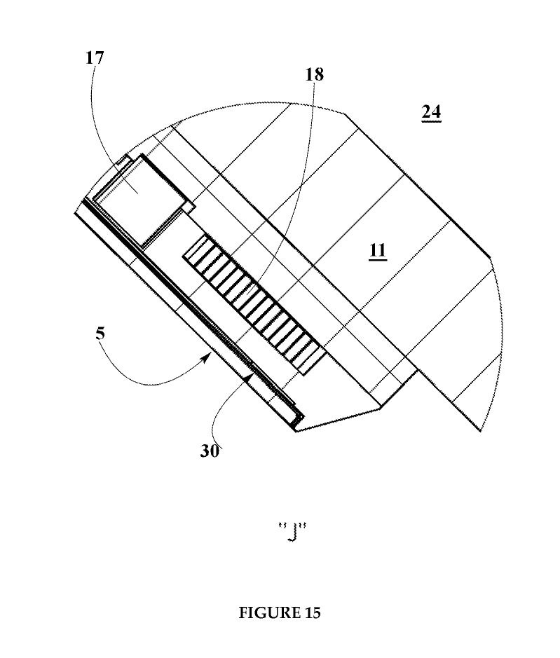

### DETAILED DESCRIPTION

A novel concept for an aseptic transfer port is disclosed. Embodiments of the present invention provide for joining and sealing together two isolated enclosures that can be cooperatively joined and opened without introducing contaminants from the environment external to the two enclosures. At least part of each enclosures may be made from a film where a hole can be created upon attachment, thereby effecting an opening. While a typical film may be made of a flexible plastic, other materials with different degrees of flexibility/rigidity are possible. A preferred embodiment involves inductively heating a metal component (e.g., plate or ring), thereby thermally cutting a hole through a plastic film. Some embodiments may optionally further include added inductively heated metal components that can effect microbial sterilization in and around the sealing area between the enclosures.

Other materials known in the art for providing a barrier impermeable to contaminants may also be used to construct the film. The type of material used to construct the film may vary based on type of contaminant that the film is meant to ward against. Similarly, the particular methods used to create a hole may vary, as known in the art, based on the type of material used. Such methods may include mechanical, electrical, magnetic, thermal, water-based, air-based, etc., means.

An exemplary aseptic transfer port may be a system comprised of two parts—an alpha port and a beta port—that can be joined together to effect the sterile transfer of materials between two isolated enclosures by means of cutting a hole in an intervening barrier.

The alpha port may typically include a door mounted on the external wall of a clean room (or isolator). Such a door separates a relatively clean area from a relatively dirty external area. This alpha port would usually incorporate safeguards to prevent it being opened unless a beta port is attached and sealed to it first. The alpha port may include a securing mechanism for holding the beta port in position while the port system is in use.

The beta port may be comprised of a set of parts attached to a container having at least a portion made from a film 2 (e.g., a plastic bag) that provide the interface that mates and seals to the alpha port and the plastic film. The beta port parts do not pierce the plastic film. As such, prior to attachment to the alpha port, there is no hole in the film.

To open the conjoined alpha and beta port, a cut may be made in the plastic film at the intersection 21 of the alpha port door assembly 11 and the mounting flange 10. After the cut is made, the cutting heater 5 and the plastic cutout 30 may move with the door assembly 11 when the port is opened. The cutting action can be any mechanical, electrical, thermal, or other means known in the art for creating a hole.

The beta port may be made by securing a set of rings to a plastic bag without cutting or perforating that film. The set of rings may include an inner plastic ring 3 on the inside of a plastic bag and an outer plastic ring 4 on the outside of the plastic bag such that a portion of the plastic bag 2 (e.g., plastic film) is compressed between these two concentric rings. Also secured in this arrangement may be a cutting heater 5 on the inside of the bag or container that can be heated by an external AC electromagnetic field (inductively).

The beta port may be positioned, temporarily secured by a latching and magnet mechanism, and sealed to the alpha port for opening and transfer operations. Magnets may be included in the door for holding and sealing the plastic cutout 30 and cutting heater 5. The seal keeps the environment between the two enclosures separate from the external environment.

In a preferred embodiment, the beta port may be opened by inductively applying heating power from the induction coil 18 in the alpha port to the cutting heater 5 and softening the plastic film 2, such that a cut (or separation) in the film is created at the intersection 21 of the mounting flange 10 and the door assembly 11 when the door is opened. The same inductive heating action can be used for microbial sanitization of the area surrounding this cut hole. Additional metal parts can be incorporated into the beta port for additional heating and sanitizing action. The door and mounting seal 12 can also incorporate an imbedded metal ring that would also be heated inductively to sanitize it and components in contact with it.

After power has been applied and the plastic film cutout has become preferentially adhered to the door on the alpha port, the door can be opened. When the door is opened, parts or material can be transferred from the bag or container into or out of the clean room 16. After using, the door may be shut, and the metal ring and other beta port and enclosure parts may be removed and discarded.

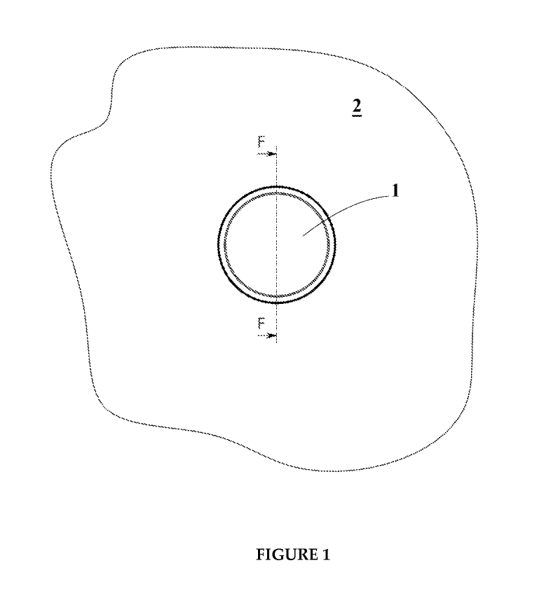

FIG. 1 shows a plan view of a typical beta port assembly 1 affixed to the inner and outer surfaces of a plastic bag 2.

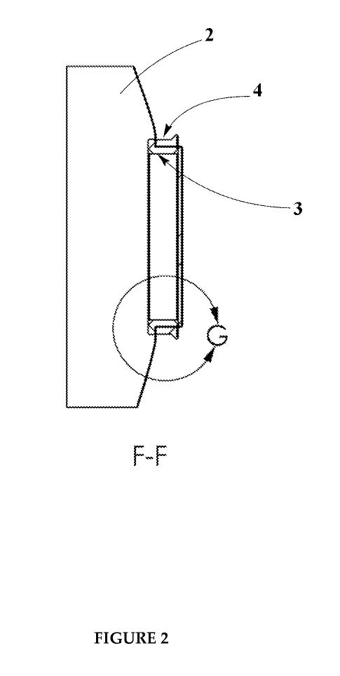

FIG. 2 shows a section of the beta port assembly 1 of FIG. 1 and shows how the beta port inner ring 3 and the outer ring 4 compresses the plastic bag 2 between them making up the beta port assembly 1.

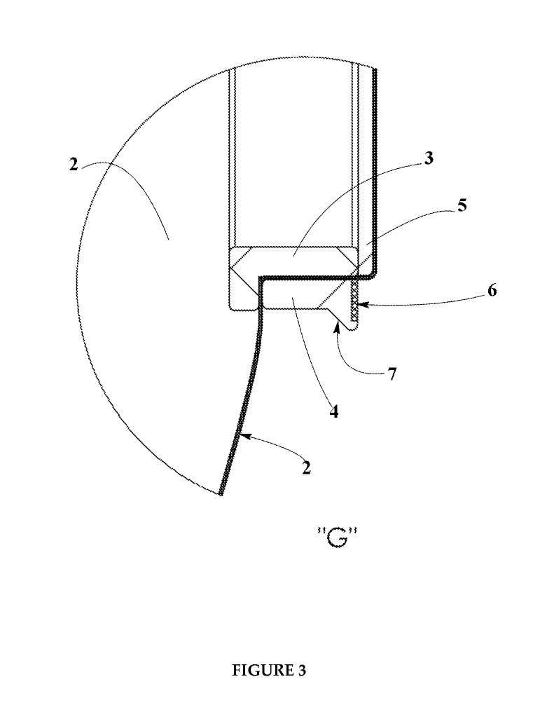

FIG. 3 shows a detail view of FIG. 2 and the parts that make up the beta port assembly 1 affixed to plastic bag 2. As illustrated, the beta port assembly may include inner ring 3, the outer ring 4, cutting heater 5, seal sanitizer 6, and retaining flange 7 of the outer ring 4. A (plastic film) portion of the plastic bag 2 is compressed between the inner ring 3 and the outer ring 4 during assembly. The retaining flange 7 of the outer ring 4 may be used to retain the beta port in place and aligned with the alpha port during transfer operations.

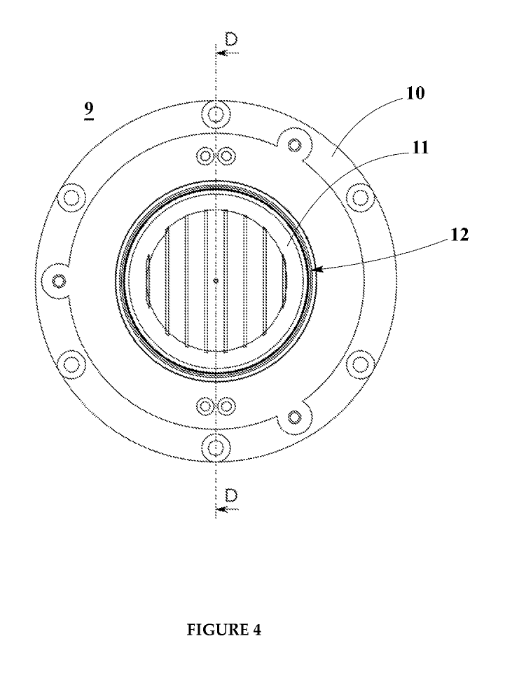

FIG. 4 shows the outside or “dirty” side 15 view of an alpha port 9. The mounting flange is illustrated as seen from outside the clean room 16 for mounting onto a clean room 16 wall. The alpha port door assembly 11 and the door and mounting seal 12 are also illustrated.

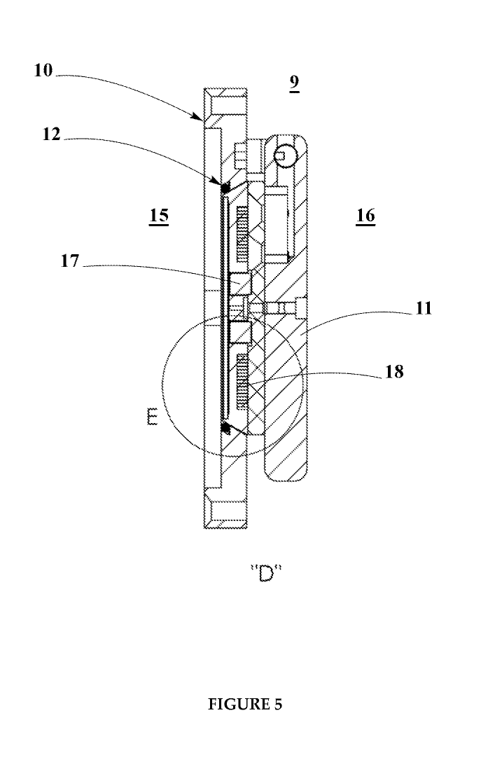

FIG. 5 shows a section view of the alpha port assembly 9 of FIG. 4. Seen are the beta port retention magnets 17, the induction coil 18, the door and mounting seal 12 and the intersection 21.

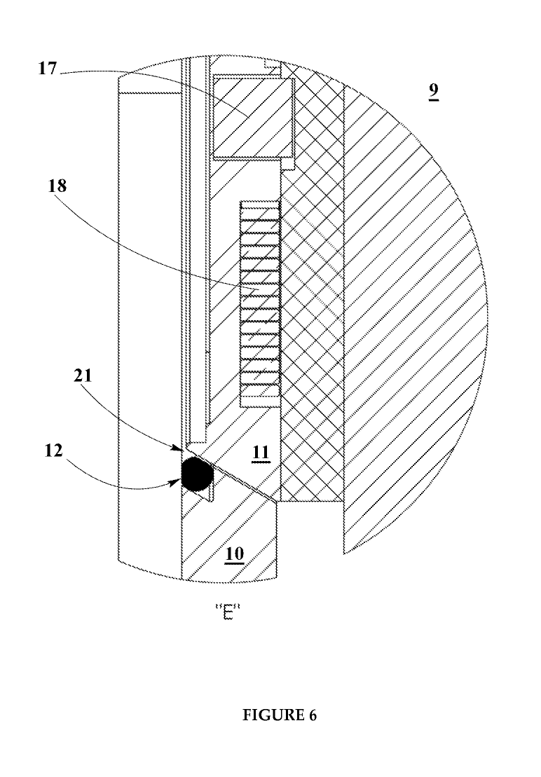

FIG. 6 shows a detail view of the section of the alpha port assembly 9 of FIG. 5. Shown are the door assembly 11, the door and mounting seal 12, the mounting flange 10, the induction coil 18, and the intersection 21.

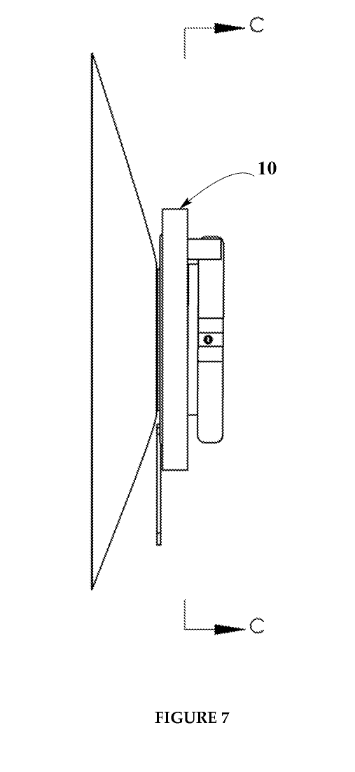

FIG. 7 is a side view of the alpha-beta port system in which the beta port is mounted to the alpha port.

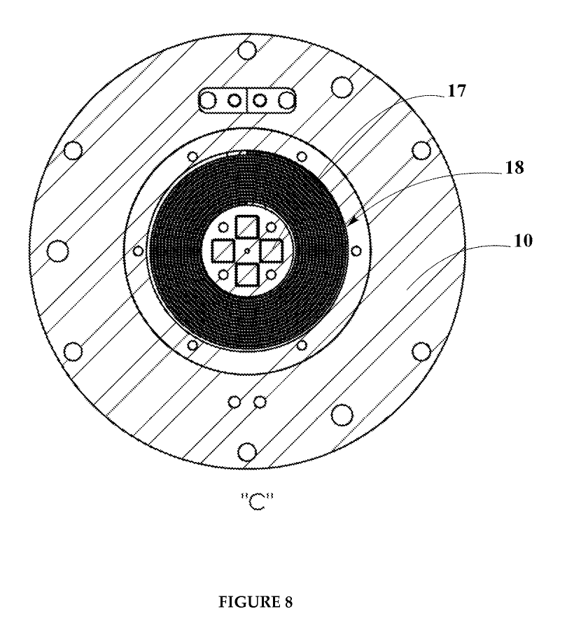

FIG. 8 is a section view of the alpha-beta port system of FIG. 7, showing the induction coil 18, beta port retention magnets 17, and mounting flange 10.

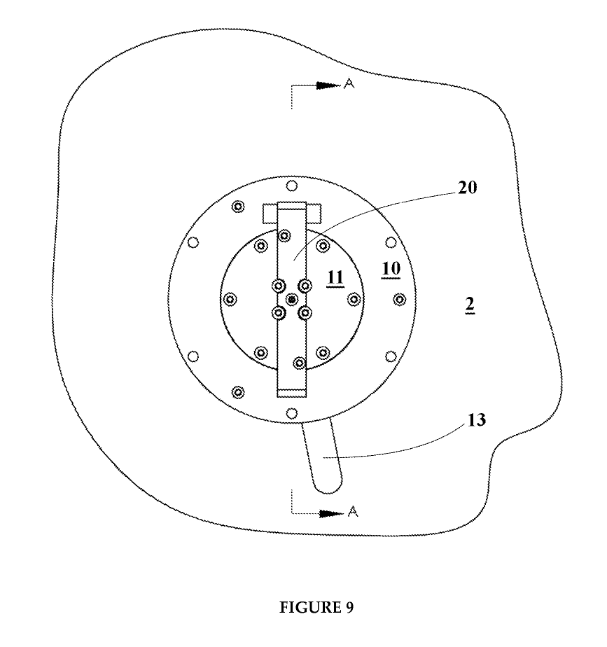

FIG. 9 is a plan view of the alpha-beta port system from the clean side in which beta port 1 is mounted to the alpha port 9. The plan view shows the door handle 20, the mounting flange 10, the locking handle 13 for securing the beta port 1 to the alpha port 9, the plastic bag 2, and the alpha port door assembly 11.

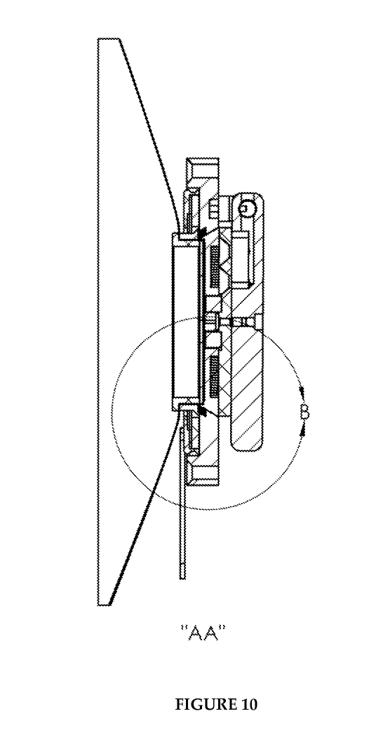

FIG. 10 is a section view of FIG. 9.

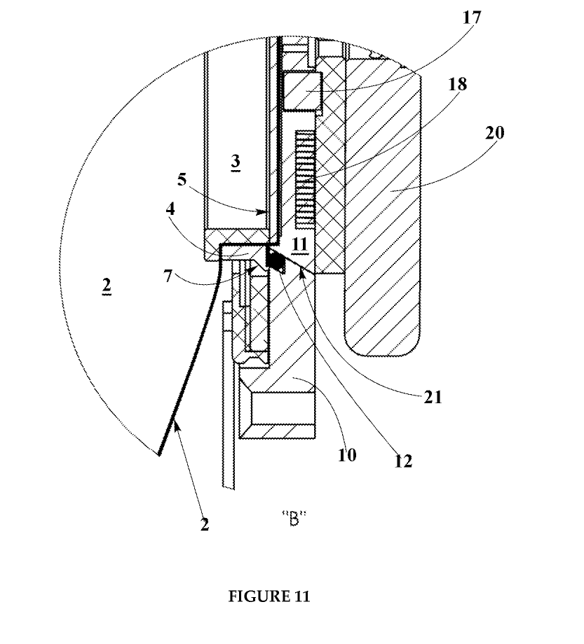

FIG. 11 is a detailed view of FIG. 10 showing the mounted alpha-beta port system. it shows the beta port assembly 1 mounted to the alpha port assembly 9.

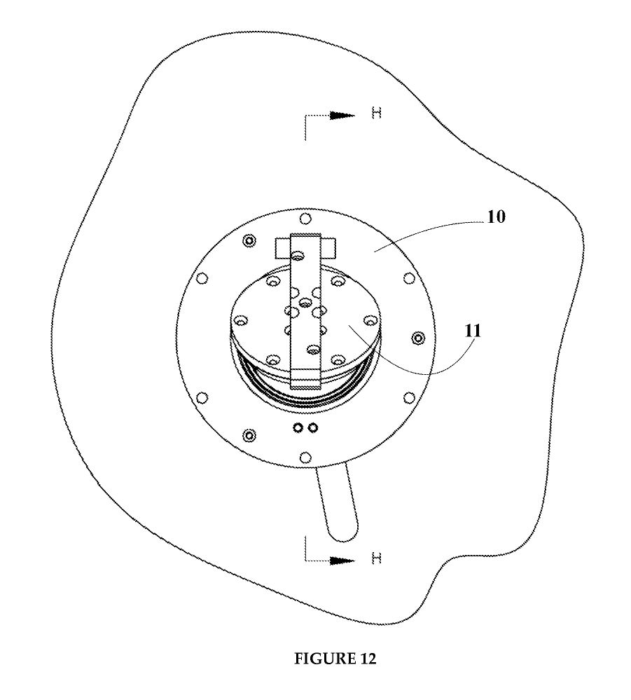

FIG. 12 is a plan view of the opened alpha-beta port system.

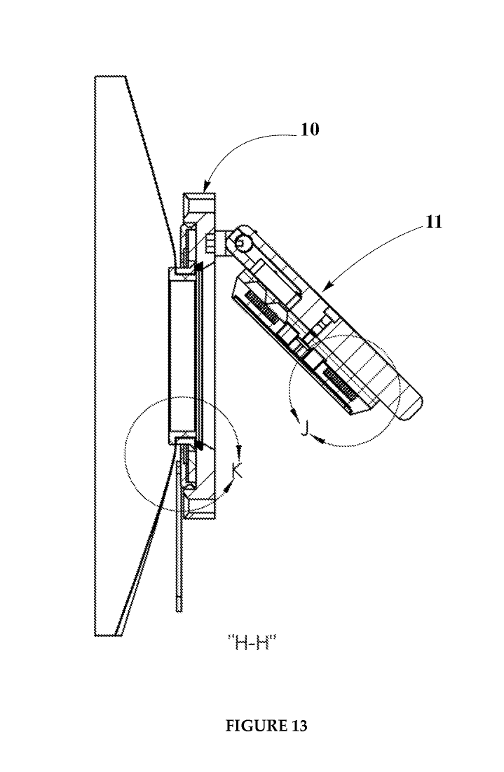

FIG. 13 is a section view of FIG. 12 showing the stationary items 22 and the door assembly 11.

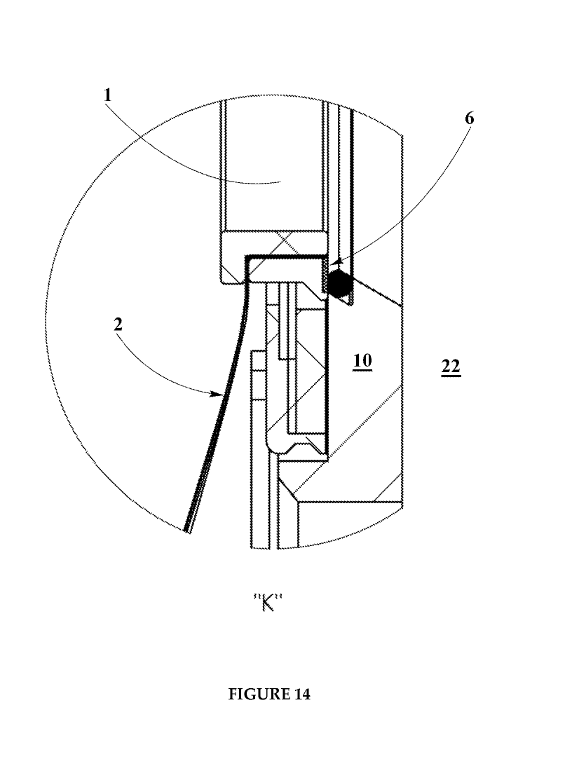

FIG. 14 is a detail view of the mounting flange 10 and the opened beta port system of FIG. 13. The plastic bag 2 has been cut near the seal sanitizer 6 by the cutting heater 5 on the door assembly 11 of the port system.

The invention embodies a method for transferring materials from a first isolated environment to a second isolated environment such that no contamination of these materials can occur from the environment outside these two isolated environments. Typically, the first isolated environment may be contained by a plastic bag 2 with a beta port 1 affixed to it, and the second environment may be a clean room or isolator with an alpha port 9 mounted in its wall. Such an assembly may be referred to as an alpha-beta assembly herein.

The beta port 1 may itself be an assembly of plastic and metal rings on the inside and outside of a plastic bag 2 or plastic film 2 that can be connected to an alpha port 9. A portion of the plastic film of plastic bag is sandwiched between the outer ring 4 and the inner ring 3 but is not pierced until the beta port 1 is opened by energy supplied from the alpha port induction coil 18.

The outer ring 4 may be of variable width and depth and include a flange extruding from a side of the ring perimeter. When the outer ring is connected to the plastic bag, the side with the flange is positioned furthest from the surface of the plastic bag.

The beta port 1 may also include an inner ring 3 that is made of a material reactive to the means for thermally creating the hole in the film. The inner ring 3 may be seated within the perimeter of the outer ring 4 and act as a cutting surface for the hole-creating means when the hole-creating means is activated to cut the film positioned within the perimeter of the first ring.

The beta port 1 may further include a plug of material of width equal to a width of the first ring which provides mechanical support to the beta port. In addition, the beta port assembly may further include a third ring that has a flange and a diameter such that the third ring fits tightly over the perimeter of the first ring on an external surface of the transfer container.

The alpha port may be mounted in the wall of an clean room or isolator and provides the opening interface to the beta port. The alpha port includes an induction coil that provides energy to the heaters on the beta and alpha port for opening and sanitizing functions. The alpha port includes a door that remains closed until a beta port is properly attached to its outside environment.

As such, the alpha-beta assembly may also include a fourth ring having a flange and an inside and outside perimeter extending through the transfer port in the barrier wall separating the first and second environments. As such, the outside perimeter of the fourth ring may be in leak-proof sealed engagement with the inner periphery of the transfer port.

Some embodiments further include a hinged door on the one side of the barrier wall moveable from a first closed position in the first passage in leak-proof sealed engagement with the inside perimeter of the first ring to a second open position free of the first passage through the first ring. Additionally, there may be a complementary locking means on the first and second rings for rigidly securing the rings together in leak-proof sealed engagement.

In some embodiments, the door may include a flexible gasket ring with a first face engageable with the first passage wall in the third ring and a second face extending through the first passage. In addition, the transfer medium cover may include a flat annular surface engageable with the second face of the door gasket ring in leak-proof sealed groove. The third ring may also include an annular inductive heating coil in the wall of the first passage through the ring adjacent to the interface between the gasket rings of the door and the transfer medium cover.

The Transfer Sequence:

A bag of clean parts with an included beta port 1 may be held in position. The beta port may be affixed onto and sealed to the alpha port 9 in such a way to ensure the isolation of the two isolated environments from the external environment.

Alternating current power may be applied to the induction coil 18, which induces eddy current and ferromagnetic hysteresis heating of the cutting heater 5 and seal sanitizer 6. The heating of the cutting heater 5 may soften the plastic film 2 to cause separation of the plastic film 2 near the seal 12 and intersection 21 when the alpha port door assembly 11 is opened. The seal sanitizer 6 can kill organisms through heat that may be present in the area around the seal 12 including the seal itself.

The alpha port door 11 may then be opened, separating the plastic film into two parts, the plastic bag 2 that remains with the beta port's inner ring 3 and outer ring 4, and the plastic cutout 30 that moves with the alpha port door 11 along with the cutting heater 5. The parts may be transferred through the now open alpha-beta port assembly illustrated in FIG. 12.

After transferring, the door may be closed and the used beta port parts may be removed and discarded.

1. A sealed system for the transfer of materials through a transfer port in a barrier wall between a first environment and a second environment, the first environment on a first side of the barrier wall and the second environment on a second side of the barrier wall, without contamination of the first environment, the system comprising:
a film associated with the transfer port in the barrier wall, wherein the film separates the first environment and the second environment;
a sealed transfer container having at least one portion comprised of the film; and
means for creating a hole in the film associated with the transfer port in the barrier wall upon connection of the sealed transfer container to the transfer port.

2. The system of claim 1, further comprising:
a first ring of variable width and depth internal to the container of the second environment having a perimeter in close contact with an internal surface of the film of the transfer container, the ring comprising a flange extruding from a perimeter furthest from the internal surface of the flexible film;
a second ring comprised of material reactive to the means for thermally creating the hole in the film, the second ring seated within the perimeter of the first ring and when subjected to the hole creation means, acting as a cutting surface of the film located within the perimeter of the first ring;
a plug of material of width equal to a width of the first ring which acts as the door of a beta port;
a third ring comprising a flange and having a diameter such that the third ring fits tightly over the perimeter of the first ring on an external surface of the transfer container;
a fourth ring having a flange and an inside and outside perimeter extending through the transfer port in the barrier wall separating the first and second environments, wherein the transfer port has an inner periphery, and the outside perimeter of the fourth ring being in leak-proof sealed engagement with the periphery of the transfer port and having a first passage through the ring;
a hinged door on the one side of the barrier wall moveable from a first closed position in the first passage in leak-proof sealed engagement with the inside perimeter of the first ring to a second open position free of the first passage through the first ring; and
a complementary locking means on the first and second rings for rigidly securing the rings together in leak-proof sealed engagement.

3. The system of claim 1, wherein the transfer container is a flexible bag located in the second environment with a beta port connected to an alpha port of the first environment.

4. The system of claim 1, wherein the ring of material reactive to the means of creating hole provides a surface for hole creation by electro-magnetic means.

5. The system of claim 1, wherein the ring of material reactive to the means of creating hole provides a surface for hole creation by mechanical means.

6. The system of claim 1, wherein the ring of material reactive to the means of creating hole provides a surface for hole creation by heat means.

7. The system of claim 1, wherein the ring of material reactive to the means of creating hole provides a surface for hole creation by water means.

8. The system of claim 1, wherein the ring of material reactive to the means of creating hole provides a surface for hole creation by air means.

9. The system of claim 1, wherein magnets that securely attach the Beta port to the hinged door of the Alpha port

10. The system of claim 1, wherein the door includes a flexible gasket ring having a first face engageable with the first passage wall in the third flanged ring and a second face extending through the first passage, and wherein the transfer medium cover includes a flat annular surface engageable with the second face of the door gasket ring in leak-proof sealed groove.

11. The system of claim 10, wherein the third flanged ring includes an annular inductive heating coil in the wall of the first passage through the ring adjacent to the interface between the gasket rings of the door and the transfer medium cover.

12. The system of claim 10, wherein the door gasket ring is sterilized by the inductive heating coil.
